(19) United States
(12) Patent Application Publication
(10) Pub. No.: US 2014/0267687 A1
(43) Pub. Date: Sep. 18, 2014

(54) VEHICULAR IMAGE PROJECTION SYSTEMS AND METHODS OF USING THE SAME

(71) Applicant: Ziaollah Loghmani, Indianapolis, IN (US)

(72) Inventor: Ziaollah Loghmani, Indianapolis, IN (US)

(21) Appl. No.: 14/216,134

(22) Filed: Mar. 17, 2014

Related U.S. Application Data
(60) Provisional application No. 61/788,317, filed on Mar. 15, 2013.

(51) Int. Cl. H04N 7/18; H04N 5/74

(52) U.S. Cl. CPC H04N 7/181; H04N 5/74
USPC 348/113

(57) ABSTRACT

Vehicular image projection systems and methods of using the same. In an exemplary embodiment of a system of the present disclosure, the system comprises one or more input devices coupled to a vehicle and configured to obtain one or more images outside of or adjacent to a vehicle, and one or more display mechanisms positioned at least partially within the vehicle and configured to display or project the one or more images obtained from the one or more input devices. In an additional embodiment, the one or more input devices and/or the one or more display mechanisms are further configured to obtain and/or display the one or more images using a personal focus relating to a driver of the vehicle.

### PRIORITY

The present application is related to, and claims the priority benefit of, U.S. Provisional Patent Application Ser. No. 61/788,317, filed Mar. 15, 2013, the contents of which are incorporated into the present disclosure in their entirety.

### BACKGROUND

Current technology known in the vehicular art for displaying an image is limited to, for example, (i) vehicle back-up cameras and displays, whereby a driver can see an image inside of the vehicle of what is behind the vehicle, (ii) GPS systems, which show computer-generated images, and not actual images, of the road and other surroundings, and (iii) personal video players, which are not used to project any sort of image from immediately outside of or adjacent to the vehicle, and are instead used to watch movies, for example. Such systems utilize displays so that a driver can see the image, but except for vehicle back-up cameras and displays, such systems do not project an image obtained immediately outside of the car. Regarding vehicle back-up cameras and displays, the displayed images are of one general view (directly behind the vehicle), and not of any sort of panoramic view, such as a 90° view, a 180° view, a 270° view, a 360° view, or a view greater than about 45° up to 360°. Furthermore, and aside from an automated focus element that may be built into vehicle back-up cameras and displays and set to automatically focus to a generic focus level, no such technology exists in the art that displays or projects an image with a focus corresponding to a driver's personal vision prescription or to a personal user focus determined by the driver to provide the driver with an optimized view of the projected or displayed image.

In view of the same, a system configured to obtain one or more images from outside of a vehicle for projection/display inside of the vehicle, whereby a driver of the vehicle uses the projected/displayed image for navigation of the vehicle, and whereby the projected/displayed image is projected/displayed with a personal user focus, would be appreciated in the commercial marketplace.

### BRIEF SUMMARY

In an exemplary embodiment of a system of the present disclosure, the system comprises one or more input devices coupled to a vehicle and configured to obtain one or more images outside of or adjacent to a vehicle, and one or more display mechanisms positioned at least partially within the vehicle and configured to display or project the one or more images obtained from the one or more input devices. In another embodiment, the one or more input devices are operable to capture multiple images. In yet another embodiment, the one or more display mechanisms are configured to display or project the multiple images in real time or close to real-time. In an additional embodiment, the one or more display mechanisms are configured to display or project the multiple images within a delay of one second or less.

In an exemplary embodiment of a system of the present disclosure, the one or more display mechanisms display or project the one or more images at a panoramic view selected from the group consisting of at least 45°, at least 90° view, at least 180° view, at least 270° view, a 360° view, and a view greater than about 45° up to 360°. In an additional embodiment, the one or more input devices and/or the one or more display mechanisms are further configured to obtain and/or display the one or more images using a personal focus relating to a driver of the vehicle. In yet an additional embodiment, a user of the system can navigate a vehicle using the one or more images displayed or projected by the one or more display mechanisms. In another embodiment, the system is configured so to display or project the one or more images without requiring any transparent or translucent panels such as a glass or plastic windshield, side windows, rear window, sunroof, and/or moon roof.

In an exemplary embodiment of a system of the present disclosure, the system comprises one or more input devices coupled to a vehicle and configured to obtain one or more images outside of or adjacent to a vehicle, one or more additional input devices not coupled to the vehicle and configured to obtain one or more additional images, and one or more display mechanisms positioned at least partially within the vehicle and configured to display or project the one or more images and the one or more additional images obtained from the one or more input devices and the one or more additional input devices. In another embodiment, the one or more input devices and the one or more additional input devices are each operable to capture multiple images. In yet another embodiment, the one or more display mechanisms are configured to display or project the multiple images in real time. In an additional embodiment, the one or more display mechanisms are configured to display or project the multiple images within a delay selected from the group consisting of longer than real time to one second, one second to two seconds, two second to five seconds, or one second or less but longer than real time.

In an exemplary embodiment of a system of the present disclosure, at least one of the one or more additional input devices is/are on the earth's surface and is/are configured to wirelessly transmit at least one of the one or more additional images to be displayed on the one or more display mechanisms. In an additional embodiment, at least another of the one or more additional input devices is/are in outer space and is/are configured to wirelessly transmit at least another of the one or more additional images to be displayed on the one or more display mechanisms. In yet an additional embodiment, at least one of the one or more display mechanisms is configured to display the at least one of the one or more images and the at least another of the one or more additional images obtained from the one of the one or more additional input devices and from the another of the one or more additional input devices. In an exemplary embodiment of a system of the present disclosure, at least one of the one or more display mechanisms is used in place of a traditional vehicle windshield. In another embodiment, at least one of the one or more display mechanisms is used in connection with a vehicle windshield.

In an exemplary embodiment of a system of the present disclosure, the system further comprises a processor in communication with the one or more display mechanisms, and a storage medium in communication with the processor, wherein at least one of the one or more images and at least one of the one or more additional images can be stored within the storage medium and retrieved from the storage medium for display on the display mechanism. In an additional embodiment, the vehicle has no transparent or translucent windows or openings permitting a driver positioned within the vehicle to see outside of the vehicle, and wherein the system is configured so that the driver can operate the vehicle to move the vehicle from a first location to a second location using the one or more display mechanisms. In yet an additional embodiment, the system is configured to identify at least one target within at least one of the one or more additional images, said identification due to identification of an identifier associated with the target.

In an exemplary embodiment of a system of the present disclosure, the system comprises one or more input devices coupled to a vehicle and configured to obtain one or more images outside of or adjacent to a vehicle, one or more additional input devices not coupled to the vehicle and configured to obtain one or more additional images, and one or more display mechanisms positioned at least partially within the vehicle and configured to display or project the one or more images and the one or more additional images obtained from the one or more input devices and the one or more additional input devices, wherein at least one of the one or more display mechanisms is used in place of a traditional vehicle windshield, wherein at least one of the one or more additional input devices is/are on the earth's surface and is/are configured to wirelessly transmit at least one of the one or more additional images to be displayed on the one or more display mechanisms. In another embodiment, at least another of the one or more additional input devices is/are in outer space and is/are configured to wirelessly transmit at least another of the one or more additional images to be displayed on the one or more display mechanisms, and wherein at least one of the one or more display mechanisms is configured to display the at least one of the one or more images and the at least another of the one or more additional images obtained from the one of the one or more additional input devices and from the another of the one or more additional input devices.

In an exemplary embodiment of a method of the present disclosure, the method comprises the steps of activating (or operating, so to “turn on”) a system, the system comprising one or more input devices coupled to a vehicle and configured to obtain one or more images outside of or adjacent to a vehicle, one or more additional input devices not coupled to the vehicle and configured to obtain one or more additional images, and one or more display mechanisms positioned at least partially within the vehicle and configured to display or project the one or more images and the one or more additional images obtained from the one or more input devices and the one or more additional input devices, and operating the vehicle to move the vehicle from a first location to a second location using the one or more display mechanisms. In an additional embodiment, the step of operating the vehicle is performed by maneuvering the vehicle based upon at least one of the one or more images and/or at least one of the one or more additional images displayed on the one or more display mechanisms.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1A shows a vehicle having a system coupled thereto, according to an exemplary embodiment of the present disclosure;

FIG. 1B shows a top view of a cut-away portion of a vehicle using a system, according to an exemplary embodiment of the present disclosure;

FIG. 1C shows a display mechanism displaying an image using a personal focus, according to an exemplary embodiment of the present disclosure;

FIG. 1D shows a display mechanism displaying an image without using a personal focus, according to an exemplary embodiment of the present disclosure;

FIG. 2 shows a component diagram, according to an exemplary embodiment of the present disclosure;

FIGS. 3 and 4 show cut-away top views of vehicles, according to exemplary embodiments of the present disclosure;

FIG. 5 shows a to view of a vehicle, according to an exemplary embodiment of the present disclosure; and

FIG. 6 shows a schematic of a vehicle on a map with input devices positioned in connection with the vehicle and outside of the vehicle, according to an exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

An exemplary system for displaying an outdoor image within a vehicle of the present disclosure is shown in FIG. 1A. As shown in FIG. 1A, system 100 comprises one or more input devices 102, such as one or more cameras configured to obtain one or more images 104 (such as one or more still images, a series of still images, and/or video) outside of a vehicle 106, and one or more display mechanisms 108, positioned at least partially within vehicle 106 and configured to display or project the one or more images 104 obtained from the one or more input devices 102.

In various embodiments of systems 100 of the present disclosure, input devices 102 are operable to capture multiple images 104, and one or more display mechanisms 108 are configured to display or project the multiple images 104, in real time or close to real-time (such as with a delay of one second or less), within vehicle 1106 04, so that such projected or displayed images are displayed at a total panoramic view of greater than about 45° up to 360°. FIG. 1B shows a top view of a cut-away portion of a vehicle 106 having using system 100, whereby an image 104 can be projected/displayed on display mechanism 108, and as shown in this exemplary embodiment, a total panoramic view of up to 360° may be achieved. Various views, such as a 45° view, a 90° view, a 180° view, a 270° view, a 360° view, or a view greater than about 45° up to 360°, may be had using systems 100 of the present disclosure.

For example, an exemplary embodiment of system 100 of the present disclosure may comprise one or more input devices 102 configured to capture images 104 (one or more photographs or video) of the surroundings adjacent to vehicle 106, and one or more display mechanisms 108 within the vehicle 106 configured to display/project the captured images 104 while a user is driving vehicle 106. The term “driving” as used herein, relates to a user controlling the operation of vehicle 106, such as while driving in forward or reverse or otherwise “behind the wheel” of vehicle 106. Such a system 100 would allow the user/driver to drive vehicle 106 without requiring transparent or translucent panels (such as a glass or plastic windshield, side windows, rear window, sunroof, and/or moon roof), allowing the user/driver, for example, to maintain as much privacy within vehicle 106 as desired.

In at least one embodiment, system 100 can be used to capture images 104 relatively in front of vehicle 106, on one or both sides, at angles between the front and one or both sides, in back, at angles between the back and one or both sides, and relatively upward and downward at various angles. For example, an input device 102 can capture images 104 relatively in front of vehicle 106, and a display mechanism 108 can display the captured images 104 so that the user/driver of vehicle 106 can see the captured images 104 inside of the vehicle 106 and drive vehicle 106 accordingly, all without requiring a windshield, for example.

In various embodiments, display mechanisms 108 can be projectors, screens (such as liquid crystal display (LCD) screens, plasma screens, and/or other display screens known or developed in the art), or other mechanisms configured to display captured images 104.

In various embodiments of systems 100 of the present disclosure, systems 100 are configured to capture or otherwise obtain images 104 (using one or more input devices 102), and display/project the captured images 104 (using one or more display mechanisms 108), whereby the displayed/projected images 104 are displayed/projected with a personal user focus based upon the user/driver of vehicle 106. FIG. 1C shows portions of a system 100 (namely a display mechanism 108 with a fully or substantially focused image 104 displayed/projected thereon), shown in FIG. 1C as being projected/displayed on a windshield. Said displayed/projected image 104 is displayed/projected using a focus tailored to the driver, and not just a general automatic focus intended for general viewing, said tailored focus optionally based upon a user's visual prescription or a setting adjusted by the driver, such as, for example, by having display mechanism 108 focused consistent with the driver's vision, or being able to adjust the focus of display mechanism 108 using a series of filters 125, for example. Without such a personal/tailored focus, the displayed/projected image would be out of focus, as shown in FIG. 1D, to the driver who has a vision impairment. For example, if a driver is relatively nearsighted, display mechanisms 108 can be configured to correct the displayed/projected images 104 for the driver, so that the driver would see displayed/projected images 104 in full or substantially full focus without the need for corrective lenses (glasses, contacts, or the like) to correct for the driver's nearsightedness. Similarly, if a driver is relatively farsighted, display mechanisms 108 can be configured to correct the displayed/projected images 104 for the driver, so that the driver would see displayed/projected images 104 in full or substantially full focus without the need for corrective lenses to correct for the driver's farsightedness.

In at least another embodiment, the personal/tailored focus may be made using input device 102, or a combination of input device 102 and display mechanism 108.

Various systems 100 of the present disclosure may comprise additional componentry to facilitate full intended use of said systems 100. For example, and as shown in the component diagram shown in FIG. 2, an exemplary system 100 of the present disclosure may comprise one or more input devices 102 coupled to or otherwise in communication with a processor 200. Processor 200 may be coupled to or otherwise in communication with a storage medium 202 capable of storing images 104 and/or instructions 204 therein, said instructions 204 (such as software code, for example) accessible by processor 200 to facilitate usage of system 100. Said components may be directly connected to one another using one or more wires 206, for example, or wirelessly using a wireless transmitter 208 and a wireless receiver 210 coupled to one or more of input device 102, display mechanism 108, processor 200, and/or storage medium 202. Other components useful to connect or otherwise operate electronic equipment known the art may also be used with various systems 100 of the present disclosure.

In view of the same, various systems 100 of the present disclosure are configured to obtain one or more images 104 from outside of a vehicle 106 for projection/display inside of the vehicle 106, whereby a driver of the vehicle 106 can use the projected/displayed images 104 for navigation of the vehicle 106, and whereby the projected/displayed images 106 are projected/displayed with a personal user focus.

In addition to the foregoing, at least some embodiments of systems 100 of the present disclosure are configured to project or display images 104 having different personal focuses, or at least one personal focus and at least one automatic focus. For example, a first display mechanism 108 may display or project images 104 having a personal focus tailored to the driver, and the first display mechanism or another display mechanism 108 may display or project the same or different images having either an automatic focus, for the benefit of one or more passengers in vehicle 106, or having a second personal focus tailored to a second passenger.

FIG. 3 shows a top view of an exemplary vehicle 106 using an exemplary system 100 of the present disclosure. As shown in FIG. 3 (upper view, with a top part of vehicle 106 cut away so to see a cross-section of the windows, for example), vehicle 106 has a plurality of windows, such as a front windshield 300, a left side front window 302, a right side front window 304, a left side rear window 306, a right side rear window 308, a rear windshield 310, and an upper window 312 (such as a sunroof or moonroof, shown in FIG. 5). Exemplary vehicles 106 may have more or less windows than shown in FIG. 3, such as coupe-style vehicle 106 that does not have a left side rear window 306 or a right side rear window 308, for example. As shown in FIG. 3, system 100 comprises a display mechanism 108 used along with each window, noting that other systems 100 of the present disclosure may use more or fewer display mechanisms 108, such as in the case of a vehicle 106 having a left side rear window 306 but no display mechanism 108 used in connection therewith. Display mechanisms 108, as generally referenced herein, can cover (take up, etc.) some or all of an identified window.

FIG. 4 shows another cut-away top view of a vehicle 106 using a system of the present disclosure. As shown in FIG. 4, vehicle 106 does not have any windows, but instead has a plurality of display mechanisms 108 used in place of, for example, one or more of a front windshield 300, a left side front window 302, a right side front window 304, a left side rear window 306, a right side rear window 308, a rear windshield 310, and an upper window 312. Other vehicles may be a hybrid of FIG. 3 and FIG. 4, namely having one or more windows without a display mechanism 108, one or more windows having a display mechanism 108, and one or more display mechanisms 108 without a corresponding window.

FIG. 5 shows an upper view (not cut-away) of a vehicle using an exemplary system 100 of the present disclosure. As shown therein, a display mechanism 108 can be used with an upper window 312, and in other embodiments, as referenced in connection with FIG. 4 for example, display mechanism 108 can be used instead of an upper window 312. Also shown in FIG. 5 are a plurality of input devices 102 (such as the two input devices 102 shown in the figure, or more than two input devices 102), so that, for example, if one input device 102 temporarily or permanently fails to capture images 104, the other input device 102 can capture images 104 and transmit the same to display mechanism 108. In various embodiments, separate input devices 102 can be used to capture images 104 and transmit the same to separate display mechanisms 108, such as one input device 102 for each display mechanism 108, for example.

In various embodiments of the present disclosure, the various windows can also operate as display mechanisms 108. For example, a front windshield 300 can be transparent so that the driver can see outside of the vehicle, while comprising or having a display mechanism 108 therein so to project or display an image 104 thereon or therein. Multiple displayed images 104 can take up some or all of an individual window, for example. A user (driver, for example) can then control whether or not the various images 104 are displayed at any given time.

FIG. 6 shows a schematic of various exemplary objects that can have input devices 102 (such as cameras, for example) in connection therewith and useful in exemplary systems 100 of the present disclosure. For example, FIG. 6 shows an exemplary system 100 having a vehicle 106 having two input devices 102 in connection therewith, noting that vehicle 106 can have one or more input devices 102 as referenced herein. FIG. 6 also shows input devices 102 as being positioned around various locations in a city map, which represents an exemplary positioning of input devices 102 at or near a street, intersection, town, city, etc., namely a general region where a vehicle 106 may travel at or near. Input devices 102 positioned around town, for example, may be coupled to, or form part of, a structure 600, such as a building, lamppost, post, telephone pole, etc. Images 102 from said input devices 102 may be transmitted to one or more display mechanisms 108 of vehicle 106 by way of one or more wireless transmitters 208, as shown in FIG. 2, and received by one or more wireless receivers 210 in communication with the one or more display mechanisms 108. In view of the same, input devices 102 (shown in connection with structures 600 in FIG. 6, for example), may be referred to herein as input devices 102 “on earth's surface” that are not coupled to vehicle 102. Said input devices 102 not coupled to vehicle 106 but on earth's surface may also comprise input devices 102 coupled to different vehicles, whereby images 104 can be shared between vehicle 106 and one or more other vehicles 106(via wireless transmission and receipt, for example).

In addition, one or more input devices 102 may be coupled to, or form part of, one or more satellites 650 positioned in outer space. Said input devices 102 can also be used to obtain images 104 and transmit the same wirelessly to vehicle 106 for display on one or more display mechanisms 108 using, for example, a wireless transmitter 208, to be received by a wireless receiver 210. In view of the same, input devices 102 (shown in connection with satellites 650 in FIG. 6, for example), may be referred to herein as input devices 102 “in outer space” that are not coupled to vehicle 106.

Images 104 from one or more of a) input device(s) 102 coupled to vehicle 106, b) input device(s) 102 not coupled to the vehicle 106 but on earth's surface, and c) input device(s) 102 in outer space, can all be displayed on display mechanism(s) 108. For example, images 104 from input device(s) 102 within or upon vehicle 106 can comprise images 104 immediately adjacent to vehicle 106. Images 104 from input device(s) 102 not coupled to the vehicle 106 but on earth's surface can comprise images 104 of locations not immediately adjacent to vehicle 106, such as ¼ mile away, ½ mile away, 1 mile away, 2 miles away, or, for example, 1/20 or more miles away, so that the driver can see said images 104 on display mechanisms 108 and know what to expect later on down the road, for example. This would be helpful in connection with route selection (due to traffic, lane closures, etc.) and to generally provide the driver with more visual information than would otherwise be available. In addition, images 104 from input device(s) 102 in outer space can comprise satellite images 104 of locations where input device(s) 102 not coupled to the vehicle 106 but on earth's surface may not be located, providing the driver with even more visual information as to what to expect while driving to a desired destination, for example. Such images 104 from various sources (various input device(s) 102) can also provide the driver with information, such as which lane to use to avoid traffic delays, assist with passing another vehicle (such as on winding or mountain roads). In addition, certain targets 625 may be identified within the one or more images 104, such as emergency vehicles (such as ambulances), police vehicles, hospitals, restaurants, rest areas, etc., so to provide the driver with additional information. Various targets 625 can have identifiers 630, such as a detectable code or transmitted or otherwise detectable signal, so that if an input device 102 identifies a target 625 within an image 104, identifier 630 can be used to identify the target 625. For example, a police car (exemplary target 625) may have an identifier 630 different from a hospital or restaurant (other types of targets 625), which can be displayed by or projected onto display mechanism 108.

In addition, various embodiments of systems 100 of the present disclosure can store images 102 (in storage medium 202, for example), with said images 102 being stored in connection with location data, such as obtained by a global positioning device 250. For example, if a driver drives a vehicle 106 along a road from point A to point B, and a series of images 104 are obtained in connection with that drive, one or more of said images 104 can be associated with a specific location, so that if a driver were to later drive along that same road from point A to point B, those images 104 can be displayed again, along with current images 104 for example, so the driver can see the comparison. This may be helpful when current conditions are not as favorable as prior conditions, such as when the recorded images 104 were obtained on a sunny day with little to no traffic, while current conditions would be less favorable, such as when driving in snow, rain, fog, darkness, and the like.

Various system 100 embodiments may further comprise one or more cover mechanisms 350 and/or one or more tint mechanisms 352 (as shown in FIG. 3) used in connection with, or forming part of, any number of windows referenced herein. Cover mechanisms 350, positioned inside or outside vehicle 106 or formed within a window itself, can be opened and closed as desired by the user to provide privacy, for example, so that people outside vehicle 106 cannot see into vehicle 106. Tint mechanisms 352 can also be turned on and off by the user to darken or lighten a window, to provide privacy, compensate for strong sunlight, etc.

While various embodiments of vehicular image projection systems and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system, comprising:
one or more input devices coupled to a vehicle and configured to obtain one or more images outside of or adjacent to a vehicle;
one or more additional input devices not coupled to the vehicle and configured to obtain one or more additional images; and
one or more display mechanisms positioned at least partially within the vehicle and configured to display or project the one or more images and the one or more additional images obtained from the one or more input devices and the one or more additional input devices.

2. The system of claim 1, wherein the one or more input devices and the one or more additional input devices are each operable to capture multiple images.

3. The system of claim 1, wherein the one or more display mechanisms are configured to display or project the multiple images in real time.

4. The system of claim 1, wherein the one or more display mechanisms are configured to display or project the multiple images within a delay selected from the group consisting of longer than real time to one second, one second to two seconds, two second to five seconds, or one second or less but longer than real time.

5. The system of claim 1, wherein the one or more display mechanisms display or project the one or more images at a panoramic view selected from the group consisting of at least 45° view, at least 90° view, at least 180° view, at least 270° view, a 360° view, and a view greater than about 45° up to 360°.

6. The system of claim 1, wherein the one or more input devices and/or the one or more display mechanisms are further configured to obtain and/or display the one or more images using a personal focus relating to a driver of the vehicle.

7. The system of claim 1, wherein a user of the system can navigate the vehicle using the one or more images displayed or projected by the one or more display mechanisms.

8. The system of claim 1, wherein the system is configured so to display or project the one or more images without requiring any transparent or translucent panels such as a glass or plastic windshield, side windows, rear window, sunroof, and/or moon roof.

9. The system of claim 1, wherein at least one of the one or more additional input devices is/are on the earth's surface and is/are configured to wirelessly transmit at least one of the one or more additional images to be displayed on the one or more display mechanisms.

10. The system of claim 9, wherein at least another of the one or more additional input devices is/are in outer space and is/are configured to wirelessly transmit at least another of the one or more additional images to be displayed on the one or more display mechanisms.

11. The system of claim 10, wherein at least one of the one or more display mechanisms is configured to display the at least one of the one or more images and the at least another of the one or more additional images obtained from the one of the one or more additional input devices and from the another of the one or more additional input devices.

12. The system of claim 1, wherein at least one of the one or more display mechanisms is used in place of a traditional vehicle windshield.

13. The system of claim 1, wherein at least one of the one or more display mechanisms is used in connection with a vehicle windshield.

14. The system of claim 1, further comprising:
a processor in communication with the one or more display mechanisms; and
a storage medium in communication with the processor;
wherein at least one of the one or more images and at least one of the one or more additional images can be stored within the storage medium and retrieved from the storage medium for display on the display mechanism.

15. The system of claim 1, wherein the vehicle has no transparent or translucent windows or openings permitting a driver positioned within the vehicle to see outside of the vehicle, and wherein the system is configured so that the driver can operate the vehicle to move the vehicle from a first location to a second location using the one or more display mechanisms.

16. The system of claim 1, wherein the system is configured to identify at least one target within at least one of the one or more additional images, said identification due to identification of an identifier associated with the target.

17. A system, comprising:
one or more input devices coupled to a vehicle and configured to obtain one or more images outside of or adjacent to a vehicle;
one or more additional input devices not coupled to the vehicle and configured to obtain one or more additional images; and
one or more display mechanisms positioned at least partially within the vehicle and configured to display or project the one or more images and the one or more additional images obtained from the one or more input devices and the one or more additional input devices;
wherein at least one of the one or more display mechanisms is used in place of a traditional vehicle windshield;
wherein at least one of the one or more additional input devices is/are on the earth's surface and is/are configured to wirelessly transmit at least one of the one or more additional images to be displayed on the one or more display mechanisms.

18. The system of claim 17,
wherein at least another of the one or more additional input devices is/are in outer space and is/are configured to wirelessly transmit at least another of the one or more additional images to be displayed on the one or more display mechanisms; and
wherein at least one of the one or more display mechanisms is configured to display the at least one of the one or more images and the at least another of the one or more additional images obtained from the one of the one or more additional input devices and from the another of the one or more additional input devices.

19. A method, comprising the steps of:
activating a system, the system comprising
one or more input devices coupled to a vehicle and configured to obtain one or more images outside of or adjacent to a vehicle,
one or more additional input devices not coupled to the vehicle and configured to obtain one or more additional images, and
one or more display mechanisms positioned at least partially within the vehicle and configured to display or project the one or more images and the one or more additional images obtained from the one or more input devices and the one or more additional input devices; and
operating the vehicle to move the vehicle from a first location to a second location using the one or more display mechanisms.

20. The method of claim 19, wherein the step of operating the vehicle is performed by maneuvering the vehicle based upon at least one of the one or more images and/or at least one of the one or more additional images displayed on the one or more display mechanisms.
